(19) United States
(12) Patent Application Publication
(10) Pub. No.: US 2025/0321947 A1
(43) Pub. Date: Oct. 16, 2025

(54) METHODS AND SYSTEMS FOR MANAGING SECONDARY DATABASE

(71) Applicant: Shopify Inc., Ottawa (CA)

(72) Inventors: Oleksiy KOVYRIN, Waterloo (CA); Cameron Pearce MORGAN, Vancouver (CA); Sivakumar NAGARAJAN, Ottawa (CA); Aaron BRADY, Ottawa (CA); Pawan Kumar DUBEY, Ottawa (CA)

(21) Appl. No.: 18/635,189

(22) Filed: Apr. 15, 2024

(51) Int. Cl. G06F 16/23; G06F 11/36; G06F 16/21

(52) U.S. Cl. CPC G06F 16/23; G06F 11/3688; G06F 16/211

(57) ABSTRACT

Methods and systems for management of a secondary database are described. Execution of a first application is monitored and one or more requests generated by the first application during execution are collected. A first set of one or more data fields requested in the one or more requests generated by the first application is identified. A database schema is generated including the first set of one or more data fields. The database schema defines a configuration of a secondary database that is a partial copy of a primary database. The secondary database is caused to be updated based on the database schema, wherein the secondary database is updated to include data copied from the first set of one or more data fields of the primary database.

### FIELD

The present disclosure relates to methods and systems for database management and more particularly to methods and systems for managing secondary databases.

### BACKGROUND

In many practical scenarios, it can be desirable to copy the data in a primary database to one or more secondary databases (e.g., to reduce latency in servicing read requests from client devices in remote locations). Generally, the data contained in the secondary database is copied from data in the primary database. However, copying of all the data in the primary database may be inefficient, for example because the client devices serviced by a secondary database only needs a portion of the data contained in the primary database. Further, copying of all the data in the primary database may require copying large amounts of data between servers, which would consume significant computing resources. Accordingly, a secondary database may contain only a subset (also referred to as a partition) of the data contained in the primary database. The configuration of the secondary database, including the selected subset of data that is copied, may be defined by a database schema.

### SUMMARY

Conventionally, a human database designer is required to perform time-consuming manual analysis to determine what subset of data in the primary database should be copied to a secondary database so that the data in the secondary database is sufficient to service read requests from applications called by client devices while avoiding having to copy data that is not needed. A problem with this conventional approach is that it requires extensive manual analysis, is very time-consuming and is prone to human error. Further, if an application is updated (which may result in the client device making new read requests for different data that might not have been copied), then it may be necessary to repeat the manual analysis and manually update the schema of the secondary database.

Another drawback of conventional techniques is that they are reliant on application developers to ensure that applications serviced by the secondary database only make read requests that can be serviced by the subset of data copied in the secondary database. If a new application is deployed that requests a data field that was not copied to the secondary database, this error may not be known until the application fails in its read request. Additionally, the attempt by the secondary database to service the read request would be a waste of computing resources.

In various examples, the present disclosure describes a technical solution for management of a read-only secondary database (also referred to as a secondary master database, or a second primary database for example) that contains data copied from a primary database (also referred to as a primary master database, a source database, or a first primary database for example). It may be noted that the secondary database is not necessarily a replica of the primary database, meaning the secondary database may have a different schema, may store data in different data structures, etc., compared to the primary database. In that sense, the secondary database may be different from conventional replica databases that typically maintain the same schema and/or data structure as the source database. However, some examples may refer to the secondary database as a replica database despite the secondary database being different from conventional replica databases as discussed above. An application (which may be deployed at the same or different server as the secondary database) may make read requests to read data stored in the secondary database. A database management engine is provided, which manages how the application, which may be called by a client device, interfaces with the secondary database. An application may only make read requests to the secondary database via the database management engine (e.g., via a database application programming interface (API) provided by the database management engine).

Prior to an application being available to be used by a client device, the application must first be deployed. In examples disclosed herein, operations are performed (e.g., by the database management engine), to automatically identify the data field(s) required to service the read request(s) generated by the application and to automatically generate an updated database schema that includes the identified data field(s). The secondary database may then be updated based on the updated database schema (e.g., add a new data field to the secondary database and copy data from the primary database to populate the added data field). Examples of the present disclosure thus provide a technical solution for managing a secondary database, including a technical solution for generating an updated database schema with little or no manual intervention.

In some examples, operations may also be performed (e.g., by the database management engine) to ensure that an application does not make any read requests that cannot be serviced by the secondary database. For example, as disclosed herein, operations may be performed prior to deployment of an application to automatically identify the data field(s) required to service the read request(s) generated by the application and compare the identified data field(s) with the database schema. If there is a data field requested by the application that is not included in the database schema, the application may be prohibited from being deployed. This provides a technical solution for preventing an application from making read requests to the secondary database that cannot be serviced by the copied data in the secondary database. This technical solution proactively identifies a potential error in the application, thus avoiding unexpected application failure and avoiding wasting computing resources.

In an example aspect, the present disclosure describes a method including: monitoring an execution of a first application and collecting one or more requests generated by the first application; identifying a first set of one or more data fields requested in the one or more requests generated by the first application; generating a database schema including the first set of one or more data fields, the database schema defining a configuration of a secondary database that is a partial copy of a primary database; and causing an update of the secondary database based on the database schema, wherein the secondary database is updated to include data copied from the first set of one or more data fields of the primary database.

In an example of the preceding example method, the method may include: after the update of the secondary database, receiving at least one further request generated by the first application; and sending data from the secondary database in response to the at least one further request to the first application.

In an example of any of the preceding example methods, the update of the secondary database may include one or more of: adding at least one data field included in the database schema to the secondary database; or removing from the secondary database at least one data field that is absent from the database schema.

In an example of any of the preceding example methods, the method may include: monitoring an execution of a second application and collecting one or more requests generated by the second application; identifying a second set of one or more data fields requested in the one or more requests generated by the second application; and generating the database schema to include a union of the first set of one or more data fields and the second set of one or more data fields; wherein the secondary database is updated to include data copied from the union of the first set of one or more data fields and the second set of one or more data fields of the primary database.

In an example of the preceding example method, the method may include: storing a first application-specific metadata identifying the first set of one or more data fields associated with the first application; and storing a second application-specific metadata identifying the second set of one or more data fields associated with the second application.

In an example of the preceding example method, the method may include: obtaining a third application-specific metadata identifying a third set of one or more data fields associated with a third application; and generating the database schema to include a union of the data fields identified in the first, second and third application-specific metadata; wherein the secondary database is updated to include data copied from the union of the data fields identified in the first, second and third application-specific metadata.

In an example of any of the preceding example methods, the method may include: after the update of the secondary database, monitoring an execution of a fourth application and collecting one or more requests generated by the fourth application; identifying a fourth set of one or more data fields requested in the one or more requests generated by the fourth application; determining that at least one data field in the fourth set of one or more data fields is absent from the database schema; and generating a notification indicating that at least one data field requested by the fourth application is absent from the database schema.

In an example of the preceding example method, the method may include: prohibiting deployment of the fourth application.

In an example of any of the preceding example methods, identifying the first set of one or more data fields requested in the one or more requests generated by the first application may include: for each request generated by the first application, parsing the request to ignore any constants in the request and to identify a requested data field; and identifying the first set of one or more data fields as a union of all requested data fields identified from the one or more requests.

In an example of any of the preceding example methods, the execution of the first application that is monitored may be a test execution of the first application prior to deployment of the first application.

In another example aspect, the present disclosure describes a computing system including a processor configured to execute instructions to cause the computing system to: monitor an execution of a first application and collect one or more requests generated by the first application; identify a first set of one or more data fields requested in the one or more requests generated by the first application; generate a database schema including the first set of one or more data fields, the database schema defining a configuration of a secondary database that is a partial copy of a primary database; and cause an update of the secondary database based on the database schema, wherein the secondary database is updated to include data copied from the first set of one or more data fields of the primary database.

In an example of the preceding example system, the processor may be configured to execute the instructions to further cause the computing system to: after the update of the secondary database, receive at least one further request generated by the first application; and send data from the secondary database in response to the at least one further request to the first application.

In an example of any of the preceding example systems, the update of the secondary database may include one or more of: addition of at least one data field included in the database schema to the secondary database; or removal from the secondary database of at least one data field that is absent from the database schema.

In an example of any of the preceding example systems, the processor may be configured to execute the instructions to further cause the computing system to: monitor an execution of a second application and collecting one or more requests generated by the second application; identify a second set of one or more data fields requested in the one or more requests generated by the second application; and generate the database schema to include a union of the first set of one or more data fields and the second set of one or more data fields; wherein the secondary database is updated to include data copied from the union of the first set of one or more data fields and the second set of one or more data fields of the primary database.

In an example of the preceding example system, the processor may be configured to execute the instructions to further cause the computing system to: store a first application-specific metadata identifying the first set of one or more data fields associated with the first application; store a second application-specific metadata identifying the second set of one or more data fields associated with the second application; obtain a third application-specific metadata identifying a third set of one or more data fields associated with a third application; and generate the database schema to include a union of the data fields identified in the first, second and third application-specific metadata; wherein the secondary database is updated to include data copied from the union of the data fields identified in the first, second and third application-specific metadata.

In an example of any of the preceding example systems, the processor may be configured to execute the instructions to further cause the computing system to: after the update of the secondary database, monitor an execution of a fourth application and collecting one or more requests generated by the fourth application; identify a fourth set of one or more data fields requested in the one or more requests generated by the fourth application; determine that at least one data field in the fourth set of one or more data fields is absent from the database schema; and generate a notification indicating that at least one data field requested by the fourth application is absent from the database schema.

In an example of the preceding example system, the processor may be configured to execute the instructions to further cause the computing system to: prohibit deployment of the fourth application.

In an example of any of the preceding example systems, the processor may be configured to execute the instructions to further cause the computing system to identify the first set of one or more data fields requested in the one or more requests generated by the first application by: for each request generated by the first application, parsing the request to ignore any constants in the request and to identify a requested data field; and identifying the first set of one or more data fields as a union of all requested data fields identified from the one or more requests.

In an example of any of the preceding example systems, the execution of the first application that is monitored may be a test execution of the first application prior to deployment of the first application.

In another example aspect, the present disclosure describes a non-transitory computer readable medium having instructions stored thereon, wherein the instructions are executable by a processor of a computing system to cause the computing system to: monitor an execution of a first application and collect one or more requests generated by the first application; identify a first set of one or more data fields requested in the one or more requests generated by the first application; generate a database schema including the first set of one or more data fields, the database schema defining a configuration of a secondary database that is a partial copy of a primary database; and cause an update of the secondary database based on the database schema, wherein the secondary database is updated to include data copied from the first set of one or more data fields of the primary database.

In some examples of the preceding example computer-readable medium, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1 is a block diagram of an example system having a primary database and a secondary database, in accordance with examples of the present disclosure;

FIG. 2 is a block diagram of an example computing system, in accordance with examples of the present disclosure;

FIG. 3 is a flowchart of an example method for generating a database schema and updating a secondary database, in accordance with examples of the present disclosure; and

FIG. 4 is a flowchart of an example method for generating a notification of a possible erroneous request generated by an application, in accordance with examples of the present disclosure.

Similar reference numerals may have been used in different figures to denote similar components.

### DETAILED DESCRIPTION

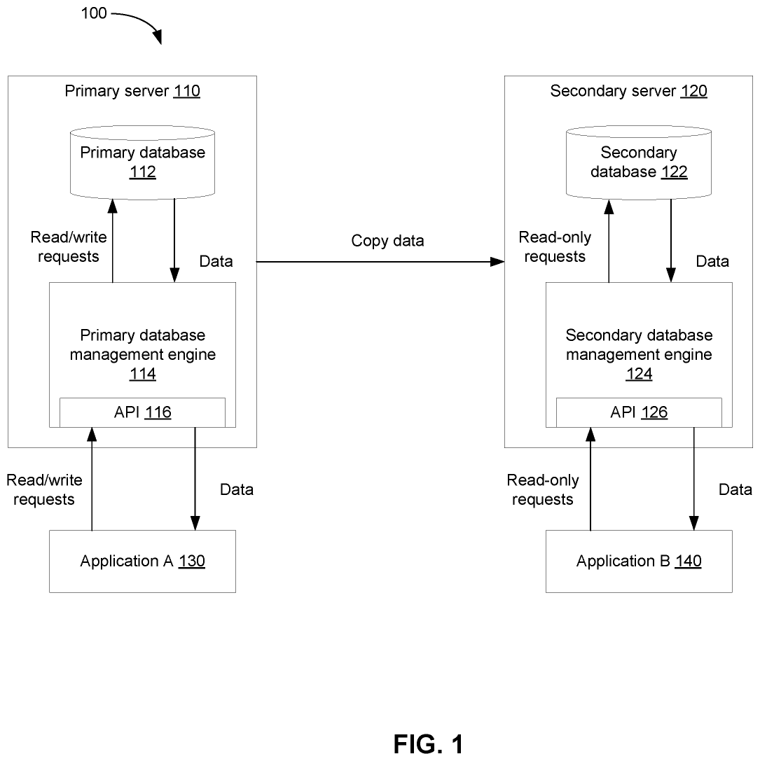

FIG. 1 illustrates an example environment in which examples of the present disclosure may be implemented. FIG. 1 illustrates an example system 100 having a primary database 112 that is hosted by a primary server 110 and a secondary database 122 that is hosted by a secondary server 120. The primary database 112 may also be referred to as a primary master database, a source database, or a first primary database, in some examples; the secondary database 122 may also be referred to as a secondary master database, or a second primary database, in some examples. In some examples, the primary and secondary servers 110, 120 may be structured query language (SQL) servers and the primary and secondary databases 112, 122 may be SQL databases. Although SQL databases may be described in examples, other types of databases (e.g., other types of relational databases) may be used within the scope of this disclosure.

The secondary database 122 in this example is a read-only database that contains data copied from the primary database 112. In particular, the secondary database 122 contains data copied from a subset (also referred to as a partition) of the data contained in the primary database 112. In this sense, the secondary database 122 may be referred to as a partial copy of the primary database 112.

In the example shown, each database 112, 122 is managed by a respective primary or secondary database management engine 114, 124. The primary database management engine 114 may perform some operations that differ from those of the secondary database management engine 124. For example, the primary database management engine 114 may permit read and write requests to the primary database 112 whereas the secondary database management engine 124 may permit only read requests to the secondary database 122. An application A 130 may make read or write requests to the primary database 112 via an application programming interface (API) 116 provided by the primary database management engine 114 and may receive data from the primary database 112 via the API 116. An application B 140 may make read-only requests to the secondary database 122 via an API 126 provided by the secondary database management engine 124. It should be noted that although APIs 116, 126 are illustrated and discussed herein, this is only exemplary. For example, a SQL proxy tool or any other object-relational mapping (ORM) tool may be used to process requests from the applications A and B 130, 140.

The configuration of each database 112, 122 may be defined by a respective database schema (not shown in FIG. 1), which may be stored by the respective database management engine 114, 124. A schema may be a type of metadata that defines certain properties of a database, such as the name of the database and data fields contained in the database (which may be expressed as data tables and columns within each table). In the present disclosure, the term “data field” is intended to encompass various ways in which data (including indexed data) may be organized in a database, including a data column, a column within a data table, or a field in which data is stored. The schema for the primary database 112 may define all the data fields contained in the primary database 112, and the schema for the secondary database 122 may define which of the data fields of the primary database 112 should be copied for the secondary database 122.

For example, the schema for the primary database 112 may be as follows:

```
name: primary
  tables:
  - name: app_extension_registrations
  columns:
    - id
    - api_client_id
    - created_at
    - title
  - name: application_icons
  columns:
    - id
    - api_client_id
    - size
    - type
    - created_at
    - icon_type
```

The above example schema configures the primary database 112 (indicated by the name “primary”) to contain a data table “app_extension_registrations” with columns “id”, “api_client_id”, “created_at” and “title”, and a data table “application_icons” with columns “id”, “api_client_id”, “size”, “type”, “created_at” and “icon_type”. A schema for the secondary database 122 that is a partial copy of the primary database 112 may be as follows:

```
name: secondary
  tables:
  - name: app_extension_registrations
  columns:
    - id
    - api_client_id
    - title
  - name: application_icons
  columns:
    - id
    - api_client_id
    - size
    - type
```

It can be seen that the schema for the secondary database 122 includes only a subset of the columns (i.e., data fields) listed in the schema for the primary database 112. Thus, the schema for the secondary database 122 defines the subset of data fields that is copied from the primary database 112.

The secondary database 122 may be regularly updated (e.g., daily, hourly, etc.) with data from the primary database 112. At each update of the secondary database 122, the secondary database management engine 124 may cooperate with the primary database management engine 114 to copy data from the primary database 112 to the secondary database 122, according to the data fields identified in the schema for the secondary database 122. Any data fields not included in the schema may not be copied to the secondary database 122.

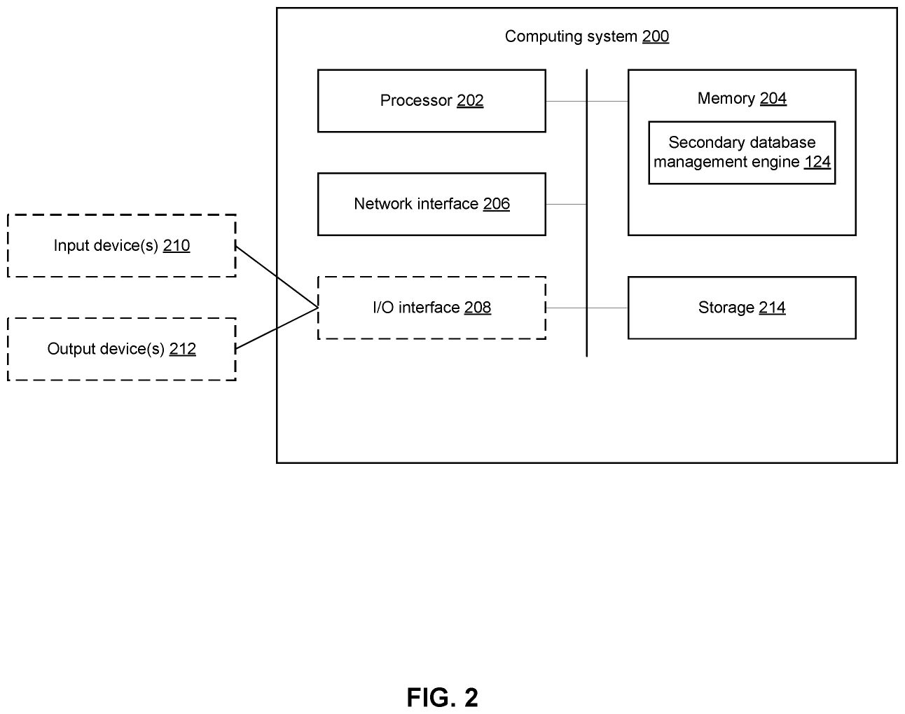

FIG. 2 illustrates an example computing system 200, which may be used to implement examples of the present disclosure. For example, the computing system 200 may be used to implement at least the secondary database management engine 124. In some examples, the computing system 200 may be used to implement the secondary server 120 that hosts the secondary database 122.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200, such as a client device requesting data from the secondary database 122 and/or communications with the primary database 112.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing the secondary database management engine 124, the operations of which are discussed in further detail below.

The computing system 200 may also include a storage unit 214, which may include a mass storage unit such as a solid state drive, a hard disk drive, a magnetic disk drive and/or an optical disk drive. The storage unit 214 may store data. In some examples, the secondary database 122 may be stored in the storage unit 214 (e.g., the computing system 200 may be the secondary server 120). In other examples, the secondary database 122 may be external to the computing system 200, for example the computing system 200 may communicate with an external system that hosts the secondary database 122 (e.g., the secondary server 120 may be external to the computing system 200).

Reference is again made to FIG. 1. As previously discussed, the secondary database 122 is a read-only partial copy of the primary database 112. Thus, applications (such as the application B 140) that make read requests to the secondary database 122 should only make requests for data fields that have been copied to the secondary database 122. Any read requests for a data field that is part of the primary database 112 but that has not been copied to the secondary database 122 will fail. The secondary database management engine 124 performs operations to automatically generate an updated schema for the secondary database 122, based on read requests generated by one or more applications that are serviced by the secondary database 122.

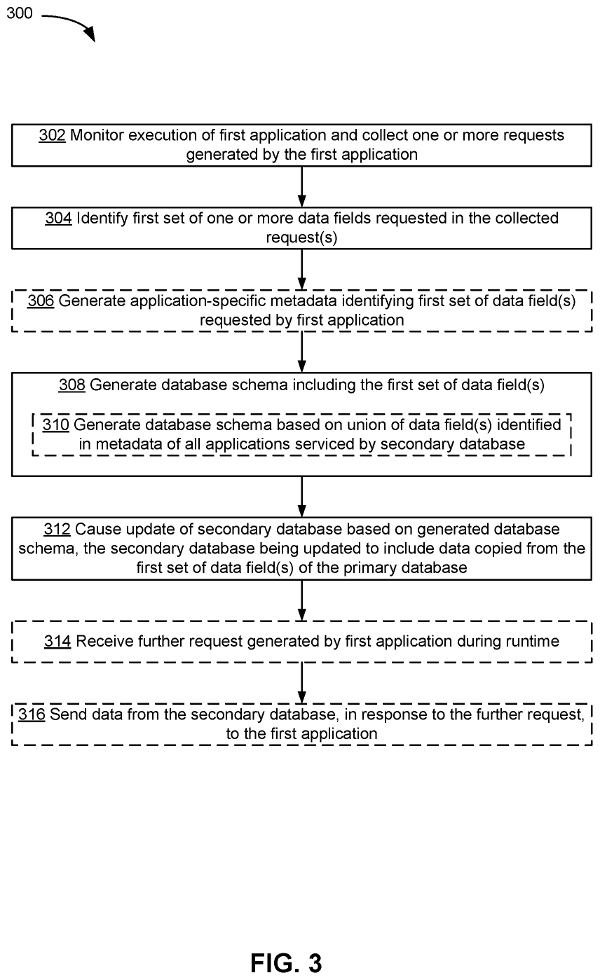

FIG. 3 is a flowchart illustrating an example method 300 that may be performed (e.g., by the secondary database management engine 124) to automatically generate an updated schema for a secondary database (e.g., the secondary database 122) that is a partial copy of a primary database (e.g., the primary database 112). The method 300 may be carried out by a computing system (e.g., the computing system 200 of FIG. 2), for example by a processor executing computer readable instructions (which may be stored in the memory of the computing system 200 or may be provided to the computing system 200, such as from an external system or from a non-transitory storage medium) to carry out the operations of the method 300.

At an operation 302, an execution of a first application is monitored and one or more requests generated by the first application are collected. For example, the first application may be a new application to be serviced by the secondary database. When the secondary database is a read-only database, the one or more requests generated by the first application should be one or more read requests. Any write requests generated by the first application may need to be rerouted to the primary database or may be denied.

The execution of the first application may occur on the same computing system that is performing the method 300 or the first application may be executed on a different computing system. For example, the first application may be executed by a client device and the execution may be monitored by an API of the secondary database management engine that receives and collects all read requests to the secondary database generated by the first application when the first application is executed. Since the secondary database management engine is the gateway by which the first application would normally request data from the secondary database, the monitoring and collecting at the operation 302 may be carried out using normal execution of the first application.

In some examples, the execution of the first application is a test execution that is performed when the first application is about to be deployed (where deployment means that the application software functionality is made fully available for execution by client devices). For example, in a continuous integration/continuous development (CI/CD) pipeline, a new application or a new version of an application may, prior to deployment, undergo a code test stage, which involves a test execution of the application. The test execution may be carried out using any suitable code coverage analysis technique, for example by using a code coverage algorithm to perform automated testing of the application. For example, the test execution may use a code coverage analysis technique that ensures that every possible branch of the application is executed or tested at least once. In some examples, the test execution may focus on executing or testing only branches of the application that are likely to generate read requests.

In other examples, the execution of the first application may not be necessarily a test execution. As will be discussed further below, a runtime execution of a deployed application may be monitored at the operation 302.

It should be noted that, generally, the read requests generated by an application may be complicated and may not be readily apparent by parsing the code within an application directly. For example, a first application may call on other applications or other functions whose code is not part of the first application and whose code may not be accessible, making it difficult if not impossible to identify data fields requested by other applications or other functions as a result of being called by the first application solely by directly analyzing lines of code. As such, execution of the first application by a computing system may be necessary in order to ensure the possible read requests generated by the first application are sufficiently collected.

At an operation 304, a first set of one or more data fields that are requested in the one or more requests generated by the first application is identified. For example, the computing system (e.g., by implementing the secondary database management engine) may automatically parse all requests generated by the first application and collected at the operation 302 to extract all data fields requested.

An example of a suitable parsing technique may be to ignore any constants in the requests in order to identify the requested data field(s) in each request, then identify the first set of data field(s) as the union of all requested data fields identified from all of the requests. For example, a suitable parsing technique may be to replace all constants in the requests with placeholder strings to enable easier combining of the collected requests, and then identify each unique data field in the combined requests.

In a simple example, the collected requests may include the following requests, which are in SQL format:

SELECT size FROM application_icons WHERE api_client_id='12345'
SELECT size FROM application_icons WHERE api_client_id='98765'

The constants ‘12345’ and ‘98765’ may be replaced with a placeholder string such as ‘42’. Then it may be identified that the requested data field in both requests is the data field “size” in the table “application_icons”, and that the data field “api_client_id” is queried. In a similar manner, all the collected requests may be parsed and each unique requested data field (which may be a column of a table, a table, a field, etc.) may be identified and added to the first set of data fields.

Optionally, at an operation 306, an application-specific metadata may be generated that identifies the first set of data field(s) requested by the first application. The application-specific metadata may be formatted similar to a schema (e.g., the application-specific metadata may identify the data field(s) requested by the first application as a list of requested columns under each requested table). The application-specific metadata may be stored for the first application. If there are multiple applications serviced by the secondary database, application-specific metadata may be generated and stored for each respective application in this manner. The application-specific metadata for each application may be generated asynchronously, for example prior to each new application or new version of an application being deployed.

In some examples, an application may already have application-specific metadata, for example the application developer may have already identified the data field(s) requested by the application in developer-defined application-specific metadata. In such cases, the developer-defined application-specific metadata may be used instead of performing the operations 302-306; or the operations 302-306 may still be performed in order to confirm the data field(s) identified in the developer-defined application-specific metadata.

At an operation 308, a database schema is automatically generated. The database schema is generated to include at least the first set of one or more data fields identified at the operation 304. The database schema defines the configuration of the secondary database, as a partial copy of the primary database. As such, the inclusion of the first set of one or more data fields in the database schema causes the secondary database to be configured to contain data from at least the first set of one or more data fields. In some examples, any data field that is not part of the first set of one or more data fields may be omitted from the database schema.

In the simple example given above, the first set of one or more data fields includes the data field “size” in the table “application_icons”. Accordingly, the generated database schema for the secondary database may be as follows:

```
name: secondary
  tables:
  - name: application_icons
  columns:
    - api_client_id
    - size
```

If application-specific metadata was generated and stored at the optional operation 306, the database schema may be generated to include a union of all the data fields identified in the application-specific metadata of all the applications serviced by the secondary database. In some examples, any data field that is not identified in any application-specific metadata of any application serviced by the secondary database may be omitted from the database schema.

At an operation 308, the computing system (e.g., by implementing the secondary database management engine) causes an update of the secondary database based on the generated database schema. In particular, the secondary database is updated such that data from the first set of one or more data fields (which are included in the database schema) is copied from the primary database to the secondary database.

In some examples, updating the secondary database may involve adding at least one data field included in the database schema to the secondary database or removing from the secondary database at least one data field that is absent from the database schema.

In some examples, if the schema includes a particular data field that is not already in the secondary database, that particular data field may be created in the secondary database. The newly created data field may not be accessible (for example, read requests for data in the particular data field may not be serviced by the secondary database) until the particular data field is fully populated with data copied from the primary database (sometimes referred to as a backfill process). However, other already-populated data fields of the secondary database may remain accessible even while the newly created particular data field is not yet accessible. In this way, adding a new data field to the secondary database and populating the new data field may take place in the background, such that applications can continue making read requests (for data in the already-populated data fields) to the secondary database while the secondary database is being updated with the new data field.

In some examples, if the schema omits a particular data field that is in the secondary database, that particular data field may be removed from the secondary database (e.g., deleting that particular data field and all data contained in that particular data field from the secondary database), which may help to free up memory resources and may increase the efficiency of the secondary server hosting the secondary database. That particular data field may be immediately flagged as inaccessible, but deleting all the data from the particular data field may occur slowly and in stages. For example, data from the particular data field may be deleted from the secondary database in chunks at times when the load on the secondary database is low.

In some examples, the method 300 may further include an operation 310 and an operation 312, which may be carried out after the secondary database has been updated following the operation 308.

At the operation 310, after updating the secondary database, a further request (e.g., a further read request for data from one or more data fields) is generated by the first application during runtime (i.e., after the first application has been deployed). The further request is received (e.g., via the API of the secondary database management engine) and used to query the secondary database. As a result of prior operations of the method 300, the data requested by the further request should be found in the data fields contained in the secondary database, thus unexpected failure of the further request can be avoided.

At the operation 312, data from the secondary database, which is obtained as a response to the further request, is sent to the first application.

The operations 310 and 312 may continue to be performed to enable the secondary database to service read requests generated by the first application. The method may return to the operation 302 when a new version of the first application is to be deployed. Additionally or alternatively, even if there is no new version of the first application to be deployed, the method may return to the operation 302 to monitor and collect read requests from the first application during runtime.

In some examples, where there is already a database schema for the secondary database, it may not be necessary to generate a new database schema if the first set of data field(s) (e.g., identified at the operation 304) is already encompassed by the current database schema for the secondary database. Instead, the application can be deployed right away without having to generate a new database schema and without requiring an update of the secondary database.

In examples where there are multiple applications serviced by the secondary database and a respective application-specific metadata is stored that identifies the data field(s) requested by each respective application, generation of the application-specific metadata and generation of the database schema may take place asynchronously. Any application whose required data field(s) (as identified in the application-specific metadata) are encompassed by the current database schema may be deployed while an application whose required data field(s) are not fully encompassed by the current database schema (e.g., at least one required data field is not found in the current database schema) must wait for an updated database schema to be generated and the secondary database to be updated (e.g., using the operations 308-312 described above) before the application can be deployed. This means that testing of a new application may occur asynchronously with updating of the secondary database.

It should also be noted that the operation 302 is not necessarily limited to being performed prior to deployment of the first application. The operation 302 may be performed for an execution of the first application that has already been deployed. This may be, for example, part of the code monitoring phase of a CI/CD pipeline. Although an application should have been tested prior to deployment, it is possible that the application was not sufficiently tested or the application receives unexpected inputs that cause the application to behave in an unexpected manner. By monitoring execution of the first application and collecting one or more read requests generated by the first application during runtime execution, a request for a particular data field that is not contained in the secondary database may be identified.

Conventionally, if an application requests a particular data field that is not contained in a database, the application would fail (e.g., the application crashes). However, using examples of the present disclosure, the computing system may perform operations to identify the particular data field as a data field that is missing from the secondary database, prior to attempting to request the data from the secondary database, and instead reroute the read request to the primary database (which contains the requested particular data field). In this way, the application can be prevented from failing. At the same time, the computing system may perform further operations (e.g., operations 304-308 as discussed above) to generate an updated schema for the secondary database that includes the particular data field, and to cause the secondary database to be updated to add the particular data field. Thus, the method 300 may be performed not only to ensure the secondary database is updated to include the necessary data fields to service an application, but also may help to reroute the read request and prevent unexpected failure of the application.

The method 300 thus enables a database schema to be automatically generated by monitoring the requests generated during execution of an application. Notably, the database schema may be proactively generated in this manner, such that the secondary database will contain data fields that are expected to be necessary to service requests from the application, even before requests are made to the secondary database during runtime of the deployed application. This enables proactive prevention of application failure when the application generates a read request for data in a data field that is not contained in the secondary database. Additionally, because the requests are generated during execution of the application, it is possible for the method 300 to account for generation of requests that may not be apparent solely from analysis of the application's source code (e.g., where the application calls on other applications or functions that in turn generate requests). As well, the method 300 enables generation of a database schema that may efficiently and effectively identify which data fields should be included in the secondary database (and also which data fields may be omitted from the secondary database) without requiring extensive manual analysis by a human.

The method 300 may be performed for generating a database schema and updating a secondary database that is a partial copy of a primary database, by proactively monitoring the execution of an application.

The present disclosure also describes examples of proactively detecting if an application would generate a read request that cannot be satisfied by the secondary database and prevent the application from making such a request.

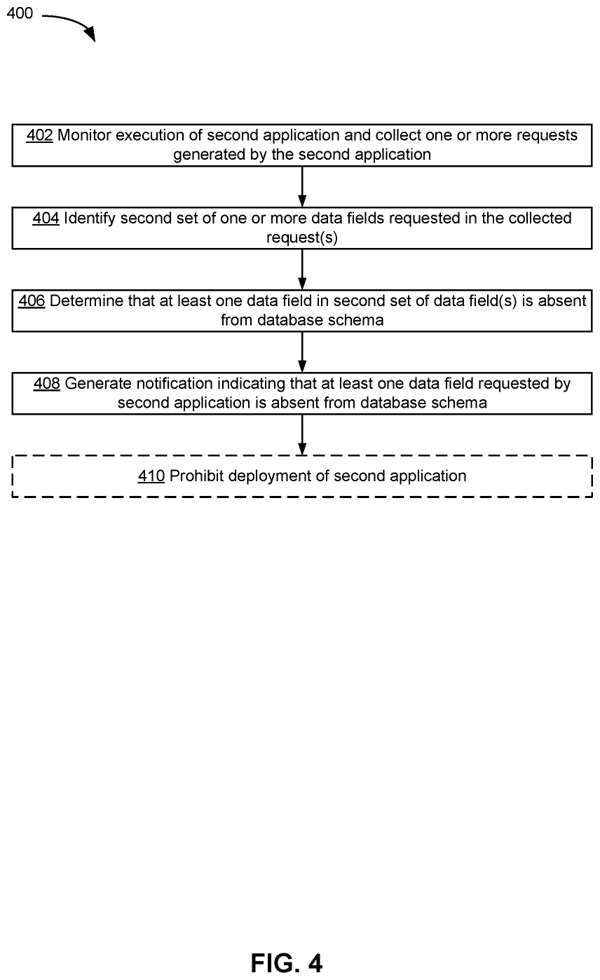

FIG. 4 is a flowchart illustrating an example method 400 for generating a notification of a possible erroneous request generated by an application. The method 400 may be performed (e.g., by the secondary database management engine 124) to automatically detect when an application would generate a request that cannot be satisfied by a secondary database (e.g., the secondary database 122) that is a partial copy of a primary database (e.g., the primary database 112). The method 400 may be carried out by a computing system (e.g., the computing system 200 of FIG. 2), for example by a processor executing computer readable instructions (which may be stored in the memory of the computing system 200 or may be provided to the computing system 200, such as from an external system or from a non-transitory storage medium) to carry out the operations of the method 400.

The method 400 may be performed during a time period when the secondary database is not being updated (e.g., after the secondary database has been updated using the method 300, the data and data fields of the secondary database may be kept static for a period of time, such as an hour or a day, to avoid excessive use of computing resources for continuously updating the secondary database). Additionally or alternatively, the method 400 may be performed for a second application that has a lower priority or lower authorization than the first application, for example the secondary database may be updated to accommodate the requests generated by the first application (e.g., using the method 300) but may not need to accommodate the requests generated by the lower priority second application.

At an operation 402, an execution of a second application is monitored and one or more requests generated by the second application are collected. For example, the second application may be a new application to be serviced by the secondary database.

At an operation 404, a second set of one or more data fields that are requested in the one or more requests generated by the second application is identified. For example, the computing system (e.g., by implementing the secondary database management engine) may automatically parse all requests generated by the second application and collected at the operation 402 to extract all data fields requested.

The operations 402 and 404 may be similar to the operations 302 and 304 described previously, and the details of the operations 302 and 304 may similarly apply to the operations 402 and 404.

If the second set of data field(s) is fully encompassed by the database schema for the secondary database (that is, all data fields requested by the second application are included in the database schema), then the second application may be deployed. For example, if the operation 402 takes place during the testing stage of the CI/CD pipeline, then subsequent stages of the CI/CD pipeline may take place to deploy the second application. If the second set of data field(s) is not fully encompassed by the database schema, then the method 400 proceeds to an operation 406.

At the operation 406, it is determined that at least one data field in the second set of data field(s) is absent from the database schema for the secondary database.

At an operation 408, a notification is generated indicating that at least one data field requested by the second application is absent from the database schema. In some examples, the notification may be an error message and may identify the data field that is absent from the database schema. Such an error message may be useful for informing a developer of the second application that the second application potentially has an error (e.g., the second application is requesting data that the developer did not intend) or that the second application cannot be deployed in its current state (e.g., the developer needs to rework the application so that the particular data field absent from the secondary database is not requested). The application developer may then take steps to correct the error in the application or modify the application. The application developer may also take steps to manually initiate an update of the secondary database in order to add the particular data field to the secondary database.

Optionally, at an operation 410, if deployment of the second application is attempted (e.g., if the execution monitored at the operation 402 is a test execution prior to deployment of the second application), deployment of the second application may be prohibited. The second application may be prohibited from deployment until the database schema and the secondary database have been updated to include all the data fields in the second set of data fields. Alternatively, the second application may be updated to avoid requesting the particular data field and the method 400 may be performed again to determine whether the second application can be deployed.

The method 400 may be useful to proactively prohibit an application from being deployed where the application cannot be fully serviced by the secondary database, thus preventing unexpected failure of the application during runtime. The application developer may be proactively informed of the potential for the application to fail (e.g., due to a request that cannot be serviced by the secondary database), thus enabling the possible error to be corrected instead of waiting for failure to occur and correcting the error afterwards. The method 400 may also be useful in scenarios in which updating the secondary database to include all data fields requested by the application is not possible, such as if a particular requested data field does not exist even in the primary database or if the secondary database is currently not able to be updated (e.g., outside of a scheduled update period).

In various examples, the present disclosure describes a technical solution that enables automated generation of a schema for a secondary database that is a partial copy of the primary database, based on monitoring the execution of an application (e.g., monitoring a test execution of the application prior to deployment). The disclosed methods and systems help to ensure that the secondary database, when configured in accordance with the generated schema, will contain sufficient data to service read requests generated by a deployed application.

Some examples of the present disclosure enable detecting that an application will make a request that cannot be serviced by the secondary database, and a notification about the potential error may be generated and/or deployment of the application may be prohibited. The requests generated by the application may be monitored during a test execution, prior to deployment, in order to proactively detect and prevent a possible failure in the event the application, when deployed, requests data from a data field that is not contained in the secondary database.

Some examples of the present disclosure capture the requests generated by an application in a test execution, prior to deployment of the application. This means that, instead of doing an after-the-fact analysis of what data fields have been requested by the application (which might have blind spots in the case of rarely run requests in the application, and also would not prevent erroneous requests from being made to the secondary database), examples of the present disclosure may proactively and automatically determine the data fields that should be included in the database schema and cause the database to be updated accordingly.

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
monitoring a test execution of a first application prior to deployment of the first application and collecting one or more read requests generated by the first application prior to the first application requesting any data from a secondary database;
identifying a first set of one or more data fields requested in the one or more read requests generated by the first application;
generating a database schema including the first set of one or more data fields, the database schema defining a configuration of the secondary database that is a partial copy of a primary database; and
causing an update of the secondary database based on the database schema, wherein the secondary database is updated to include data copied from the first set of one or more data fields of the primary database.

2. The method of claim 1, further comprising:
after the update of the secondary database, receiving at least one further read request generated by the first application after the first application is deployed; and
sending data from the secondary database in response to the at least one further read request to the first application.

3. The method of claim 1, wherein the update of the secondary database includes one or more of:
adding at least one data field included in the database schema to the secondary database; or
removing from the secondary database at least one data field that is absent from the database schema.

4. The method of claim 1, further comprising:
monitoring an execution of a second application and collecting one or more read requests generated by the second application;
identifying a second set of one or more data fields requested in the one or more read requests generated by the second application; and
generating the database schema to include a union of the first set of one or more data fields and the second set of one or more data fields;
wherein the secondary database is updated to include data copied from the union of the first set of one or more data fields and the second set of one or more data fields of the primary database.

5. The method of claim 4, further comprising:
storing a first application-specific metadata identifying the first set of one or more data fields associated with the first application; and
storing a second application-specific metadata identifying the second set of one or more data fields associated with the second application.

6. The method of claim 5, further comprising:
obtaining a third application-specific metadata identifying a third set of one or more data fields associated with a third application; and
generating the database schema to include a union of the data fields identified in the first, second and third application-specific metadata;
wherein the secondary database is updated to include data copied from the union of the data fields identified in the first, second and third application-specific metadata.

7. The method of claim 1, further comprising:
after the update of the secondary database, monitoring an execution of a fourth application and collecting one or more read requests generated by the fourth application;
identifying a fourth set of one or more data fields requested in the one or more read requests generated by the fourth application;
determining that at least one data field in the fourth set of one or more data fields is absent from the database schema; and
generating a notification indicating that at least one data field requested by the fourth application is absent from the database schema.

8. The method of claim 7, further comprising:
prohibiting deployment of the fourth application.

9. The method of claim 1, wherein identifying the first set of one or more data fields requested in the one or more read requests generated by the first application comprises:
for each read request generated by the first application, parsing the read request to ignore any constants in the read request and to identify a requested data field; and
identifying the first set of one or more data fields as a union of all requested data fields identified from the one or more read requests.

10. The method of claim 1, wherein the first application is deployed after the secondary database is updated.

11. A computing system comprising:
a processor configured to execute instructions to cause the computing system to:
monitor a test execution of a first application prior to deployment of the first application and collect one or more read requests generated by the first application prior to the first application requesting any data from a secondary database;
identify a first set of one or more data fields requested in the one or more read requests generated by the first application;
generate a database schema including the first set of one or more data fields, the database schema defining a configuration of the secondary database that is a partial copy of a primary database; and
cause an update of the secondary database based on the database schema, wherein the secondary database is updated to include data copied from the first set of one or more data fields of the primary database.

12. The system of claim 11, wherein the processor is configured to execute the instructions to further cause the computing system to:
after the update of the secondary database, receive at least one further read request generated by the first application after the first application is deployed; and
send data from the secondary database in response to the at least one further read request to the first application.

13. The system of claim 11, wherein the update of the secondary database includes one or more of:
addition of at least one data field included in the database schema to the secondary database; or
removal from the secondary database of at least one data field that is absent from the database schema.

14. The system of claim 11, wherein the processor is configured to execute the instructions to further cause the computing system to:
monitor an execution of a second application and collecting one or more read requests generated by the second application;
identify a second set of one or more data fields requested in the one or more read requests generated by the second application; and
generate the database schema to include a union of the first set of one or more data fields and the second set of one or more data fields;
wherein the secondary database is updated to include data copied from the union of the first set of one or more data fields and the second set of one or more data fields of the primary database.

15. The system of claim 14, wherein the processor is configured to execute the instructions to further cause the computing system to:
store a first application-specific metadata identifying the first set of one or more data fields associated with the first application;
store a second application-specific metadata identifying the second set of one or more data fields associated with the second application;
obtain a third application-specific metadata identifying a third set of one or more data fields associated with a third application; and
generate the database schema to include a union of the data fields identified in the first, second and third application-specific metadata;
wherein the secondary database is updated to include data copied from the union of the data fields identified in the first, second and third application-specific metadata.

16. The system of claim 11, wherein the processor is configured to execute the instructions to further cause the computing system to:
after the update of the secondary database, monitor an execution of a fourth application and collecting one or more read requests generated by the fourth application;
identify a fourth set of one or more data fields requested in the one or more read requests generated by the fourth application;
determine that at least one data field in the fourth set of one or more data fields is absent from the database schema; and
generate a notification indicating that at least one data field requested by the fourth application is absent from the database schema.

17. The system of claim 16, wherein the processor is configured to execute the instructions to further cause the computing system to:
prohibit deployment of the fourth application.

18. The system of claim 11, wherein the processor is configured to execute the instructions to further cause the computing system to identify the first set of one or more data fields requested in the one or more read requests generated by the first application by:
for each read request generated by the first application, parsing the read request to ignore any constants in the request and to identify a requested data field; and
identifying the first set of one or more data fields as a union of all requested data fields identified from the one or more read requests.

19. The system of claim 11, wherein the first application is deployed after the secondary database is updated.

20. A non-transitory computer readable medium having instructions stored thereon, wherein the instructions are executable by a processor of a computing system to cause the computing system to:
monitor a test execution of a first application prior to deployment of the first application and collect one or more read requests generated by the first application prior to the first application requesting any data from a secondary database;
identify a first set of one or more data fields requested in the one or more read requests generated by the first application;
generate a database schema including the first set of one or more data fields, the database schema defining a configuration of the secondary database that is a partial copy of a primary database; and
cause an update of the secondary database based on the database schema, wherein the secondary database is updated to include data copied from the first set of one or more data fields of the primary database.
